(19) United States
(12) Patent Application Publication
(10) Pub. No.: US 2020/0016912 A1
(43) Pub. Date: Jan. 16, 2020

(54) PRINTING APPARATUS AND POWER SUPPLY CIRCUIT

(71) Applicant: SEIKO EPSON CORPORATION, Tokyo (JP)

(72) Inventor: Akihiro UNO, Matsumotoi-shi (JP)

(73) Assignee: SEIKO EPSON CORPORATION, Tokyo (JP)

(21) Appl. No.: 16/507,816

(22) Filed: Jul. 10, 2019

(30) Foreign Application Priority Data
Jul. 11, 2018 (JP) 2018-131492

(51) Int. Cl. B41J 29/393; H02M 3/156

(52) U.S. Cl. CPC B41J 29/393; H02M 3/156

(57) ABSTRACT

A printing apparatus includes a printing mechanism, a control circuit, and a power supply circuit. The power supply circuit includes a main power supply that supplies a voltage, an input voltage control circuit that, based on the voltage, generates a plurality of driving voltages for the control circuit and a reset signal for the control circuit, a switching circuit that supplies the voltage to the input voltage control circuit, an enabling circuit that, based on the voltage, supplies an enable signal to the input voltage control circuit, and a multi-contact switch that, when being in an ON state, supplies the voltage to the switching circuit and the enabling circuit. The input voltage control circuit receives the enable signal from the enabling circuit after elapsing a predetermined period, generates, based on the enable signal, the plurality of driving voltages and the reset signal, and supplies to the control circuit.

The present application is based on, and claims priority from JP Application Serial Number 2018-131492, filed Jul. 11, 2018, the disclosure of which is hereby incorporated by reference herein in its entirety.

### BACKGROUND

### 1. Technical Field

The present disclosure relates to a printing apparatus and a power supply circuit.

### 2. Related Art

Research and development have been conducted on technology for securing the reliability, the safety, and any other performance quality of a control circuit such as a central processing unit (CPU) or the like.

There is a case in which normal operation is secured in a way that allows a period whose length is longer than or equal to a predetermined length to be ensured as a period from the application of power until the supply of a plurality of driving voltages to a control circuit. Particularly, when the power is applied to the control circuit again, the completion of discharging for the control circuit is necessary, and the specification must be such that a period until the completion of the discharging is ensured.

With respect to the ensuring of the period until the completion of the discharging for the control circuit, there is disclosed a power supply circuit that, when power is applied to a target apparatus or the power is applied thereto again, allows the timing of the supply of driving voltages to the control circuit to be delayed by means of a reset integrated circuit (IC) or the like (see, for example, JP-A-2008-236873 and JP-A-2010-017067). Here, the target apparatus is an apparatus including the control circuit. The target apparatus is, for example, a printing apparatus or the like.

In the power supply circuit written in JP-A-2008-236873 or JP-A-2010-017067, a reset IC including a regulator circuit is provided, or a regulator circuit that is an entity different from the reset IC is provided together with the reset IC. For this reason, in the target apparatus, the reduction of the mounting area of the power supply is difficult. This difficulty of the reduction of the mounting area of the power supply circuit is likely to become an obstacle to the downsizing of the target apparatus. Here, the regulator circuit is a circuit that generates a driving voltage different from the driving voltages used by the control circuit, and supplies the generated different driving voltage to the reset IC.

### SUMMARY

In order to solve the above-described problem, a printing apparatus according to an aspect of the present disclosure includes a printing mechanism that performs printing on a medium, a control circuit that controls the printing mechanism, and a power supply circuit. Further, the power supply circuit includes a main power supply that supplies a voltage, an input voltage control circuit that, based on the voltage, generates a plurality of driving voltages for the control circuit and a reset signal for the control circuit, a switching circuit that supplies the voltage to the input voltage control circuit, an enabling circuit that, based on the voltage, supplies an enable signal to the input voltage control circuit, and a multi-contact switch that, when being in an ON state, supplies the voltage to the switching circuit and the enabling circuit. Further, the input voltage control circuit is configured to receive the enable signal from the enabling circuit after elapsing a predetermined period of time from the ON state of the multi-contact switch, generate based on the enable signal, the plurality of driving voltages and the reset signal, and supply the plurality of driving voltages and the reset signal to the control circuit at predetermined timing.

Further, a power supply circuit according to another aspect of the present disclosure is of a printing apparatus including a printing mechanism, and includes a main power supply that supplies a voltage, a control circuit that controls the printing mechanism, an input voltage control circuit that, based on the voltage, generates a plurality of driving voltages for the control circuit and a reset signal for the control circuit, a switching circuit that supplies the voltage to the input voltage control circuit, an enabling circuit that, based on the voltage, supplies an enable signal to the input voltage control circuit, and a multi-contact switch that, when being in an ON state, supplies the voltage to the switching circuit and the enabling circuit. Further, the input voltage control circuit is configured to receive the enable signal from the enabling circuit after elapsing a predetermined period of time from the ON state of the multi-contact switch, generate, based on the enable signal, the plurality of driving voltages and the reset signal, and supply the plurality of driving voltages and the reset signal to the control circuit at predetermined timing.

### BRIEF DESCRIPTION OF THE DRAWINGS

FIG. 1 is a diagram illustrating an example of the functional configuration of a printing apparatus according to an embodiment of the present disclosure.

FIG. 2 is a diagram illustrating an example of the circuit configuration of a power supply circuit according to the embodiment.

FIG. 3 is a diagram illustrating an example of the change of the voltage of a capacitor included in an enabling circuit according to the embodiment, within a period from the timing of the application of power to the printing apparatus until the timing of the disconnection of the supply of the power thereto.

### DESCRIPTION OF EXEMPLARY EMBODIMENTS

### Embodiment

Hereinafter, an embodiment of the present disclosure will be described with reference to the drawings.

### Outline of Printing Apparatus

First, the outline of a printing apparatus according to the embodiment will be described.

The printing apparatus includes a printing mechanism that performs printing on a medium, a control circuit that controls the printing mechanism, and a power supply circuit including a main power supply that supplies a main voltage. Further, the power supply circuit includes an input voltage control circuit that, based on the main voltage, generates a plurality of driving voltages supplied to the control circuit and a reset signal for resetting the control circuit, a switching circuit that supplies the main voltage to the printing mechanism and the input voltage control circuit, an enabling circuit that, based on the main voltage, generates an enable signal and supplies the generated enable signal to the input voltage control circuit, and a multi-contact switch that, while being switched to its ON state, supplies the main voltage to the switching circuit and the enabling circuit. Further, based on the supplied enable signal, the input voltage control circuit supplies the plurality of driving voltages and the reset signal to the control circuit at predetermined timing.

With this configuration, the printing apparatus can be configured such that the reliability, the safety, and any other performance quality of the control circuit are secured concurrently with the reduction of the mounting area of the power supply circuit. Consequently, for example, the printing apparatus can be configured such that its overall size is reduced in a state in which the reliability, the safety, and any other performance quality of the control circuit remain secured. Hereinafter, the configuration of such a printing apparatus will be described in detail.

### Configuration of Printing Apparatus

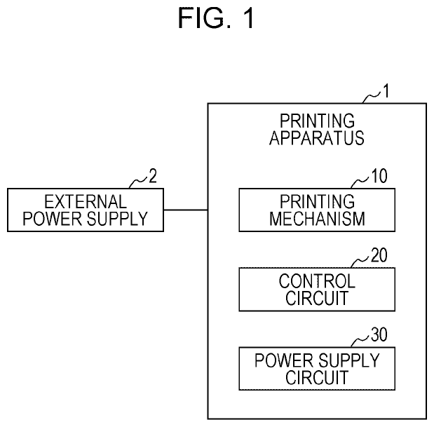

Hereinafter, the functional configuration of a printing apparatus 1, according to the present embodiment, will be described with reference to FIG. 1. Here, the printing apparatus 1 is one example of the foregoing printing apparatus.

FIG. 1 is a diagram illustrating an example of the functional configuration of the printing apparatus 1 according to the present embodiment. The printing apparatus 1 is coupled to an external power supply 2. Further, the printing apparatus 1 is supplied with an alternating-current voltage from the external power supply 2. Hereinafter, as an example, a case in which the external power voltage 2 is a power supply that supplies an alternating-current voltage of 100 volts will be described. Note that the external power supply may be, instead of the above type of power supply, a power supply that supplies an alternating-current voltage lower than 100 volts, a power supply that supplies an alternating-current voltage higher than 100 volts, or a power supply that supplies a direct-current voltage.

The printing apparatus 1 includes a printing mechanism 10, a control circuit 20, and a power supply circuit 30. Note that the printing apparatus 1 may be configured to include, in addition to the above components, one or more mechanisms, one or more circuits, one or more apparatuses, and/or the like.

The printing mechanism 10 is an example of the foregoing printing mechanism. The printing mechanism 10 includes various kinds of mechanisms necessary for performing printing of an image on a medium. The printing mechanism 10 is controlled by the control circuit 20. The printing mechanism 10 performs the printing on the medium in response to a request from the control circuit 20. The medium is, for example, paper, such as printing paper or the like. Note that the medium may be a medium other than the paper, such as a seal mount or the like. Here, for the configuration of the printing mechanism 10, any configuration may be employed.

The control circuit 20 is an example of the foregoing control circuit. The control circuit 20 controls the printing mechanism 10. The control circuit 20 operates based on a plurality of driving voltages supplied from the power supply circuit 30. Further, the control circuit 20 is reset based on a reset signal supplied from the power supply circuit 30. The resetting of the control circuit 20 is an operation that causes the initialization of various kinds of logic circuits included in the control circuit 20 to their predetermined states. The control circuit 20 is capable of operating in a normal state by being reset.

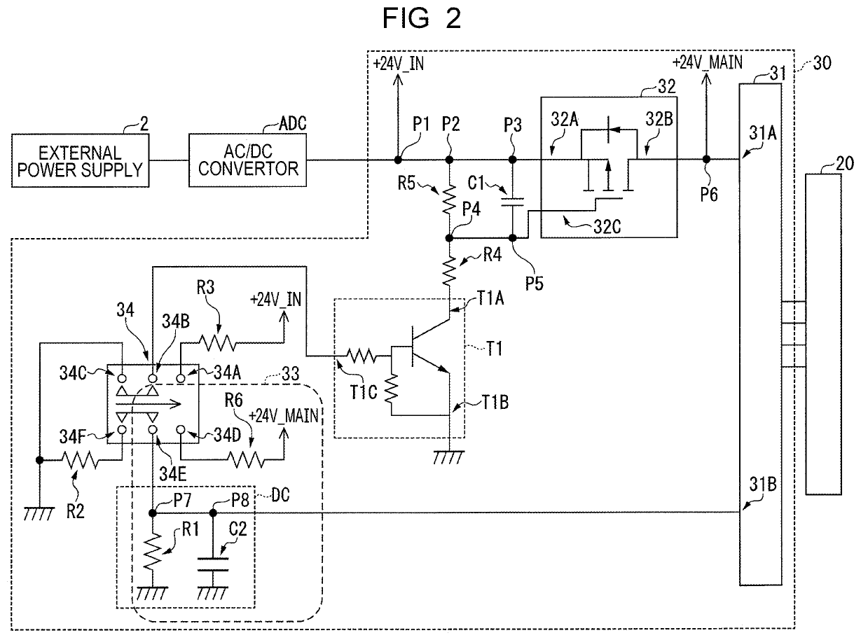

The power supply circuit 30 is an example of the foregoing power supply circuit. The power supply circuit 30 is coupled to the above-described external power supply 2 via, for example, a cable. The power supply circuit 30 includes an alternating current (AC)/direct current (DC) convertor ADC (see FIG. 2). The AC/DC convertor ADC converts an alternating-current voltage of 100 volts into a direct-current voltage of 24 volts. Note that the AC/DC convertor ADC may be configured to convert the alternating-current voltage of 100 volts into a direct-current voltage lower than 24 volts, or may be configured to convert the alternating-current voltage of 100 volts into a direct-current voltage higher than 24 volts. Further, the AC/DC convertor may be a DC/DC convertor when the external power supply 2 is a power supply for supplying a direct-current voltage. Further, there may be employed a configuration in which a DC/DC convertor is coupled between the AC/DC convertor and the power supply circuit 30. Further, the AC/DC convertor ADC may be an entity different from the power supply circuit 30. The AC/DC convertor ADC is an example of the foregoing main power supply. Further, the direct-current voltage of 24 volts, which is supplied from the AC/DC convertor ADC to the power supply circuit 30, is an example of the main voltage (the voltage of the main power supply).

The power supply circuit 30 generates the plurality of driving voltages, supplied to the control circuit 20, based on the direct-current voltage of 24 volts supplied from the AC/DC convertor ADC. The power supply circuit 30 supplies the generated plurality of driving voltages to the control circuit 20. Hereinafter, a case in which the plurality of driving voltages are three driving voltages of 3.3 volts, 1.1 volts, and 1.5 volts will be described. Note that the plurality of driving voltages may be two driving voltages, or may be four or more driving voltages. Further, part or the whole of the plurality of driving voltages may be one or more driving voltages each having any other voltage value. The power supply circuit 30 supplies the generated plurality of driving voltages to the control circuit 20.

Here, a driving voltage of 3.3 volts among the three driving voltages, supplied from the power supply circuit 30 to the control circuit 20, is a voltage for driving the logic circuits of the control circuit 20. The driving voltage of 3.3 volts is an example of a first voltage described later. Further, one of the logic circuits of the control circuit 20 is an example of an input/output handler described later. Further, a driving voltage of 1.1 volts among the three driving voltages, supplied from the power supply circuit 30 to the control circuit 20, is a voltage for driving the core of an unillustrated central processing unit (CPU) included in the control circuit 20. The driving voltage of 1.1 volts is an example of a second voltage described later. Further, the CPU included in the control circuit 20 is an example of a controller described later. Further, a driving voltage of 1.5 volts among the three driving voltages, supplied from the power supply circuit 30 to the control circuit 20, is a voltage for driving an unillustrated random access memory (RAM) included in the control circuit 20. The driving voltage of 1.5 volts is an example of a third voltage described later. Further, the RAM included in the control circuit 20 is an example of a storage medium described later.

The power supply circuit 30 generates the reset signal for resetting the control circuit 20, together with the plurality of driving voltages supplied to the control circuit 20. The power supply circuit 30 supplies the generated reset signal, together with the plurality of generated driving voltages, to the control circuit 20. At this time, the power supply circuit 30 supplies the generated plurality of driving voltages and the generated reset signal to the control circuit 20 at predetermined timing. The predetermined timing will be described later.

### Circuit Configuration of Power Supply Circuit

Hereinafter, the circuit configuration of the power supply circuit 30 will be described with reference to FIG. 2. FIG. 2 is a diagram illustrating an example of the circuit configuration of the power supply circuit 30. Here, in the following description of the present embodiment, electric conductors for transmitting electric power will be referred to as transmission paths. The transmission paths are, for example, electric conductors printed on a substrate. Note that the transmission paths may be other electric conductors instead of the electric conductors printed on the substrate.

First, individual circuit elements included in the power supply circuit 30, and the coupling configuration of the individual circuit elements included in the power supply circuit 30 will be described.

The power supply circuit 30 includes an input voltage control circuit 31, a switching circuit 32, an enabling circuit 33, a multi-contact switch 34, a first capacitor C1, a second resistor R2 to a fifth resistor R5, as four resistors, and a transistor T1.

The input voltage control circuit 31 generates the three driving voltages, supplied to the control circuit 20, and the reset signal, for resetting the control circuit 20, based on the direct-current voltage of 24 volts, supplied from the AC/DC convertor ADC. The input voltage control circuit 31 includes a first terminal 31A and a second terminal 31B. The first terminal 31A is a terminal supplied with the direct-current voltage of 24 volts, supplied from the AC/DC convertor ADC. The second terminal 31B is a terminal supplied with the enable signal.

The switching circuit 32 supplies the direct-current voltage of 24 volts to the printing mechanism 10 and the input voltage control circuit 31. The switching circuit 32 is, for example, a P-type metal-oxide-semiconductor field-effect transistor (MOSFET). The switching circuit 32 includes three terminals, namely, a first terminal 32A to a third terminal 32C. The first terminal 32A is a source terminal of the switching circuit 32, which is the P-type MOSFET. The second terminal 32B is a drain terminal of the switching circuit 32, which is the P-type MOSFET. The third terminal 32C is a gate terminal of the switching circuit 32, which is the P-type MOSFET.

Here, the switching circuit 32 is switched to any one of its ON and OFF states in accordance with the magnitude of a voltage supplied to the third terminal 32C, which is the gate terminal. In the switching circuit 32 being in its ON state, the electric conduction between the first terminal 32A and the second terminal 32B is established. In the switching circuit 32 being in its OFF state, the electric conduction between the first terminal 32A and the second terminal 32B is not established.

The enabling circuit 33 generates the enable signal based on the direct-current voltage of 24 volts. The enabling circuit 33 supplies the generated enable signal to the input voltage control circuit 31. The enabling circuit 33 includes a second capacitor C2, a first resistor R1, and a sixth resistor R6.

The multi-contact switch 34 is a double-pole/double-throw type switch, and includes six terminals, namely, a first terminal 34A to a sixth terminal 34F. The multi-contact switch 34 is switched to its ON state when the power has been applied to the printing apparatus 1 (for example, when a power switch of the printing apparatus 1 has been switched to its ON state). On the other hand, the multi-contact switch 34 is switched to its OFF state when the supply of the power to the printing apparatus 1 has been disconnected (for example, when the power switch of the printing apparatus 1 has been switched to its OFF state). In the multi-contact switch 34 having been switched to its ON state, the first terminal 34A and the second terminal 34B are electrically coupled to each other, and the fourth terminal 34D and the fifth terminal 34E are electrically coupled to each other. In the multi-contact switch 34 having been switched to its OFF state, the second terminal 34B and the third terminal 34C are electrically coupled to each other, and the fifth terminal 34E and the sixth terminal 34F are electrically coupled to each other. While the multi-contact switch 34 is switched to its ON state, the multi-contact switch 34 supplies the direct-current voltage of 24 volts to the switching circuit 32 and the enabling circuit 33. Note that the multi-contact switch 34 is switched to any one of its ON and OFF states, but is never switched to any one of its states other than its ON and OFF states. That is, the multi-contact switch 34 is never switched to any one of its other states, such as a state in which the first terminal 34A and the second terminal 34B are electrically coupled to each other, and simultaneously therewith, the fifth terminal 34E and the sixth terminal 34F are electrically coupled to each other.

The transistor T1 is, for example, an NPN type transistor. The transistor T1 includes three terminals, namely, a first terminal T1A to a third terminal T1C. The first terminal T1A is the collector terminal of the transistor T1, which is the NPN-type transistor. The second terminal T1B is the emitter terminal of the transistor T1, which is the NPN-type transistor. The third terminal T1C is the base terminal of the transistor T1, which is the NPN-type transistor.

Here, the transistor T1 is switched to any one of its ON and OFF states in accordance with the magnitude of an electric current supplied to the third terminal T1C, which is the base terminal. In the transistor T1 being in its ON state, the electric conduction between the first terminal T1A and the second terminal T1B is established. In the transistor T1 being in its OFF state, the electric conduction between the first terminal T1A and the second terminal T1B is not established.

An output terminal included in the AC/DC convertor ADC is coupled to the first terminal 32A of the switching circuit 32 via a transmission path. On this transmission path interconnecting the output terminal included in the AC/DC convertor ADC and the first terminal 32A, there are provided a first contact point P1, a second contact point P2, and a third contact point P3 in order of the first contact point P1, the second contact point P2, and the third contact point P3 in a direction from the AC/DC convertor ADC toward the switching circuit 32.

The first contact point P1 is coupled to the first terminal 34A of the multi-contact switch 34 via a transmission path. On this transmission path interconnecting the first contact point P1 and the first terminal 34A, there is provided the third resistor R3 described above.

The second contact point P2 is coupled to the first terminal T1A of the transistor T1 via a transmission path. On this transmission path interconnecting the second contact point P2 and the first terminal T1A, there is provided a fourth contact point P4. Further, the fifth resistor R5 is provided between the second contact P2 and the fourth contact point P4 on the transmission path interconnecting the second contact point P2 and the first terminal T1A. Moreover, the fourth resistor R4 is provided between the fourth contact point P4 and the first terminal T1A on the transmission path interconnecting the second contact point P2 and the first terminal T1A.

The fourth contact point P4 is coupled to the third terminal 32C of the switching circuit 32 via a transmission path. On this transmission path interconnecting the fourth contact point P4 and the third terminal 32C, there is provided a fifth contact point P5.

The fifth contact point P5 is coupled to the third contact point P3 via a transmission path. On this transmission path interconnecting the fifth contact point P5 and the third contact point P3, there is provided the first capacitor C1. The first capacitor C1 suppresses the rapid supply of a large voltage to the third terminal 32C of the switching circuit 32.

The second terminal 32B of the switching circuit 32 is coupled to the first terminal 31A of the input voltage control circuit 31 via a transmission path. On this transmission path interconnecting the second terminal 32B and the first terminal 31A, there is provided a sixth contact point P6.

The sixth contact point P6 is coupled to the fourth terminal 34D of the multi-contact switch 34 via a transmission path. On this transmission path interconnecting the sixth contact point P6 and the fourth terminal 34D, there is provided the sixth resistor R6 included in the enabling circuit 33. Further, the sixth contact point P6 is coupled to the printing mechanism 10, which is not illustrated, via a transmission path.

The second terminal T1B of the transistor T1 is coupled to the ground via a transmission path.

The third terminal T1C of the transistor T1 is coupled to the second terminal 34B of the multi-contact switch 34 via a transmission path.

The third terminal 34C of the multi-contact switch 34 is coupled to the ground via a transmission path.

The fifth terminal 34E of the multi-contact switch 34 is coupled to the second terminal 31B of the input voltage control circuit 31 via a transmission path. On this transmission path interconnecting the fifth terminal 34E and the second terminal 31B, there are provided a seventh contact point P7 and an eighth contact point P8 in order of the seventh contact point P7 and the eighth contact point P8 in a direction from the multi-contact switch 34 toward the input voltage control circuit 31.

The seventh contact point P7 is coupled to the ground via a transmission path. On this transmission path interconnecting the seventh contact point P7 and the ground, there is provided the first resistor R1.

The eighth contact point P8 is coupled to the ground via a transmission path. On this transmission path interconnecting the eighth contact point P8 and the ground, there is provided the second capacitor C2.

Next, the operation of the power supply circuit 30 based on such a circuit configuration will be described.

When the multi-contact switch 34 is in its OFF state, the transistor T1 is in its OFF state. Consequently, the switching circuit 32 is in its OFF state. That is, the switching circuit 32 does not supply the direct-current voltage of 24 volts to the printing mechanism 10 and the input voltage control circuit 31.

Further, when the multi-contact switch 34 is in its OFF state, electric charge stored in the second capacitor C2 is discharged through the second resistor R2. For this reason, when a period when the multi-contact switch 34 is in its OFF state is longer than a period until the completion of the discharging of the electric charge stored in the second capacitor C2 through the second resistor R2, there is no stored electric charge in the second capacitor C2.

Here, when the multi-contact switch 34 having been in its OFF state has been switched to its ON state, the supply of the direct-current voltage of 24 volts to the transistor T1 through the first contact point P1 is started. Further, the state of the transistor T1 is switched from its OFF state to its ON state. Consequently, the state of the switching circuit 32 is switched from its OFF state to its ON state. That is, the switching circuit 32 supplies the direct-current voltage of 24 volts to the printing mechanism 10 and the input voltage control circuit 31.

Upon start of the supply of the direct-current voltage of 24 volts from the switching circuit 32 to the printing mechanism 10 and the input voltage control circuit 31, the supply of the direct-current voltage of 24 volts to the enabling circuit 33 through the sixth contact point P6 is also started. Consequently, in the enabling circuit 33, the charging of the second capacitor C2 is started. Upon start of the charging of the second capacitor C2, a voltage having a magnitude equivalent to the amount of electric charge having been charged in the second capacitor C2 is started to be supplied to the second terminal 31B of the input voltage control circuit 31. Further, when the charging of the second capacitor C2 has been completed, the direct-current voltage of 24 volts is supplied, as the enable signal, to the second terminal 31B of the input voltage control circuit 31. The enable signal is a signal that allows the input voltage control circuit 31 to start the generation of the three driving voltages (that is, the enable signal being a signal that initiates a power supply sequence). That is, the enabling circuit 33 generates the enable signal based on the supplied direct-current voltage of 24 volts. The enabling circuit 33 supplies the generated enable signal to the second terminal 31B of the input voltage control circuit 31.

Here, the second capacitor C2 allows the timing at which the direct-current voltage of 24 volts is supplied, as the enable signal, to the input voltage control circuit 31 to be delayed by a period of time (a predetermined period of time) taken until the charging of the second capacitor C2 is completed, in such a way as described above. For this reason, the first resistor R1, the sixth resistor R6, and the second capacitor C2 operate as a delay circuit DC illustrated in FIG. 2 in the enabling circuit 33. The second capacitor C2 is an example of the capacitor.

Upon supply of the enable signal, based on the supplied enable signal, the input voltage control circuit 31 supplies the three driving voltages and the reset signal to the control circuit 20 at predetermined timing. The predetermined timing may be any timing, provided that the predetermined timing corresponds to timing points at which the respective three driving voltages and reset signal are supplied to the control circuit 20 in order of, for example, the driving voltage of 3.3 volts, the driving voltage of 1.1 volts, the driving voltage of 1.5 volts, and the reset signal.

Here, in the control circuit 20, in order to secure the normal operation of the control circuit 20, the charging of various kinds of capacitors included in the control circuit 20 is needed to be completed at timing prior to the supply of the three driving voltages. For this reason, for conventional printing apparatuses, there has been employed a configuration that delays a period of time from the timing of the application of power to a conventional printing apparatus until the supply of driving voltages by means of, for example, the reset integrated circuit (IC) or the like. For such a configuration in which the conventional printing apparatus is provided with the reset IC, however, in the conventional printing apparatus, difficulty has sometimes arisen in reducing the mounting area of circuitry by the mounting area of the reset IC.

Thus, the printing apparatus 1 is provided with the power supply circuit 30 illustrated in FIG. 2. The power supply circuit 30 can be configured such that, even when the reset IC is not provided, the capacitance of the second capacitor C2, the resistance value of the first resistor R1, and the resistance value of the sixth resistor R6 are adjusted by a manufacture, a designer, or the like, and thereby, the period of time from the timing of the application of power to the printing apparatus 1 until the supply of the three driving voltages to the control circuit 20 is delayed by a period of time equivalent to the capacitance of the second capacitor C2, the resistance value of the first resistor R1, and the resistance value of the sixth resistor R6. Consequently, the printing apparatus 1 can be configured such that the mounting area of the power supply circuit 30 is reduced in a state in which the reliability, the safety, and any other performance quality of the control circuit 20 remain secured.

Further, in the power supply circuit 30, there is provided the enabling circuit 33 that allows such a delay period of time to arise by means of single components (discrete parts), such as a resistor, a capacitor, and the like. For this reason, the power supply circuit 30 can be configured such that its mounting area is reduced and the increase of its manufacturing cost is suppressed, concurrently with the securing of the reliability, the safety, and any other performance quality of the control circuit 20.

Meanwhile, when the multi-contact switch 34 having been in its ON state is switched to its OFF state, the state of the transistor T1 is switched from its ON state to its OFF state. Consequently, the state of the switching circuit 32 is switched from its ON state to its OFF state. That is, the switching circuit 32 does not supply the direct-current voltage of 24 volts to the printing mechanism 10 and the input voltage control circuit 31. In other words, the power supply circuit 30 disconnects the supply of the direct-current voltage of 24 volts to the switching circuit 32.

Further, when the multi-contact switch 34 having been in its ON state is switched to its OFF state, the fifth terminal 34E and the sixth terminal 34F of the multi-contact switch 34 are coupled to each other. For this reason, the electric charge of the second capacitor C2 (namely, the electric charge having been stored in the second capacitor C2) is discharged to the ground through the second resistor R2. Here, the power supply circuit 30 can be configured such that a period of time during which the electric charge of the second capacitor C2 is discharged is adjusted by the adjustment of the resistance value of the second resistor R2 by a manufacture, a designer, or the like. Specifically, the smaller the resistance value of the second resistance R2 is made, the shorter the period of time during which the electric charge of the second capacitor C2 is discharged becomes.

Here, in the power supply circuit 30, as illustrated in FIG. 2, a resistor associated with the charging of the second capacitor C2 and a resistor associated with the discharging of the second capacitor C2 are mutually different resistors. With this configuration, the power supply circuit 30 can be configured such that both of the lengthening of the delay period of time from the timing of the application of power to the printing apparatus 1 until the supply of the three driving voltages to the control circuit 20, and the shortening of the discharge period of time of the second capacitor C2 are achieved without increasing the capacitance of the second capacitor C2. It is unnecessary to increase the capacitance of the second capacitor C2, and thus, the printing apparatus 1 can be configured such that the increase of its manufacturing cost is suppressed. Note that, in this one example, a resistor associated with the discharging of the second capacitor C2 corresponds to the above-described first resistor R1. Further, in this one example, a resistor associated with the charging of the second capacitor C2 corresponds to the above-described second resistor R2.

Further, as described above, the power supply circuit 30 can be configured such that the lengthening of the delay period of time from the timing of the application of power to the printing apparatus 1 until the supply of the three driving voltages to the control circuit 20, and the shortening of the discharge period of time of the second capacitor C2 are achieved. For this reason, the power supply circuit 30 can be configured such that the discharging of the second capacitor C2 is completed even when the application of power to the printing apparatus 1 and the disconnection of the supply of the power to the printing apparatus 1 are repeated within a short period of time (for example, approximately one second). Consequently, the control circuit 20 can be configured such that a period until the completion of the discharging for the control circuit 20 is ensured. That is, the power supply circuit 30 can be configured such that the reliability, the safety, and any other performance quality of the control circuit 20 are secured.

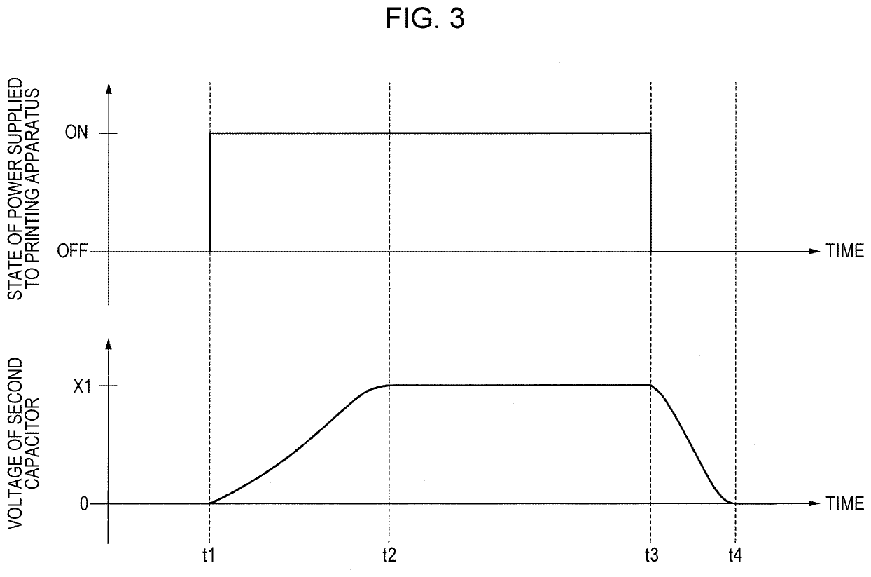

Here, FIG. 3 is a diagram illustrating an example of the change of the voltage of the second capacitor C2 within a period from the timing of the application of power to the printing apparatus 1 until the timing of the disconnection of the supply of the power thereto. Here, the period from the timing of the application of power to the printing apparatus 1 until the timing of the disconnection of the supply of the power thereto is, for example, a period from the timing at which the power supply switch of the printing apparatus 1 is switched to its ON state until the timing at which the power supply switch is switched to its OFF state. The horizontal axis of two graphs illustrated in FIG. 3 indicates time. The vertical axis of an upper-side graph illustrated in FIG. 3 indicates the state of power supplied to the printing apparatus 1. A reference sign “ON” on the vertical axis of the upper-side graph illustrated in FIG. 3 indicates a state in which the power is applied to the printing apparatus 1. Further, a reference sign “OFF” on the vertical axis of the upper-side graph illustrated in FIG. 3 indicates a state in which the supply of the power to the printing apparatus 1 is disconnected. That is, a time t1 illustrated in FIG. 3 indicates timing at which the power has been applied to the printing apparatus 1. Further, a time t3 illustrated in FIG. 3 indicates timing at which the supply of the power to the printing apparatus 1 has been disconnected.

Further, the vertical axis of a lower-side graph illustrated in FIG. 3 indicates a voltage of the second capacitor C2. Further, a reference sign “X1” on the vertical axis of the lower-side graph illustrated in FIG. 3 indicates the voltage of the second capacitor C2 with its charging completed. That is, a time t2 illustrated in FIG. 3 indicates timing at which the charging of the second capacitor C2 has been completed. Here, when the voltage of the second capacitor C2 has reached “X1”, the direct-current voltage of 24 volts is started to be supplied, as the enable signal, to the second terminal 31B of the input voltage control circuit 31. That is, the printing apparatus 1 can be configured such that the length of a period from the time t1 until the time t2 is adjusted by the adjustment of the capacitance of the second capacitor C2 and the resistance value of the first resistor R1 by a manufacturer, a designer, or the like. For example, when the period of time necessary for the discharging for the control circuit 20 is 100 milliseconds, in the printing apparatus 1, the capacitance of the second capacitor C2 and the resistance value of the first resistor R1 are adjusted by a manufacturer, a designer, or the like in such a way that the length of the period from the time t1 until the time t2 becomes 100 milliseconds or more. With this configuration, the printing apparatus 1 can be configured such that the reliability, the safety, and any other performance quality of the control circuit 20 are secured concurrently with the reduction of the mounting area of the power supply circuit 30.

Further, when the supply of the power to the printing apparatus 1 has been disconnected at a time t3, the above-described state of the multi-contact switch 34 is switched from its ON state to its OFF state. Consequently, the electric charge of the second capacitor C2 (namely, the electric charge having been stored in the second capacitor C2) is discharged to the ground through the second resistor R2, as described above. A time t4 illustrated in FIG. 3 indicates timing at which the discharging of the second capacitor C2 has been completed. That is, the printing apparatus 1 can be configured such that the length of a period from the time t3 until the time t4 is adjusted by the adjustment of the resistance value of the second resistor R2 by a manufacturer, a designer, or the like. The length of the period from the time t3 until the time t4 is, for example, several milliseconds, but is not limited to this value.

Here, the resistance value of the second resistor R2 is preferable to be smaller than the resistance value of the first resistor R1. This is because, in this case, the period from the time t3 until the time t4 is shorter than the period from the time t1 until the time t2. Consequently, the printing apparatus 1 can be configured such that, for example, even when the application of power and the disconnection of the supply of the power are repeated within a short period of time by a user, the period of time necessary for the discharging of the second capacitor C2 is shortened simultaneously with the lengthening of the period of time from the timing of the application of power to the printing apparatus 1 until the supply of the three driving voltages to the control circuit 20. Note that the resistance value of the second resistor R2 may be larger than or equal to the resistance value of the first resistor R1.

As described above, the printing apparatus in the present embodiment (the printing apparatus 1 in the above one example) includes a printing mechanism (the printing mechanism 10 in the above one example) that performs printing on a medium, a control circuit (the control circuit 20 in the above one example) that controls the printing mechanism, and a power supply circuit (the power supply circuit 30 in the above one example) including a main power supply (the AC/DC convertor ADC in the above one example) that supplies a main voltage (the alternating-current voltage of 24 volts in the above one example). Further, the power supply circuit includes an input voltage control circuit (the input voltage control circuit 31 in the above one example) that, based on the main voltage, generates a plurality of driving voltages supplied to the control circuit and a reset signal for resetting the control circuit, a switching circuit (the switching circuit 32 in the above one example) that supplies the main voltage to the printing mechanism and the input voltage control circuit, and an enabling circuit (the enabling circuit 33 in the above one example) that, based on the main voltage, supplies an enable signal to the input voltage control circuit, and a multi-contact switch (the multi-contact switch 34 in the above one example) that, while being switched to an ON state, supplies the main voltage to the switching circuit and the enabling circuit. Further, upon receipt of the supply of the enable signal from the enabling circuit after an elapse of a predetermined period of time from the ON state of the multi-contact switch, based on the enable signal, the input voltage control circuit generates the plurality of driving voltages and the reset signal, and supplies the plurality of driving voltages and the reset signal to the control circuit at predetermined timing. With this configuration, the printing apparatus can be configured such that the reliability, the safety, and any other performance quality of the control circuit are secured concurrently with the reduction of the mounting area of the power supply circuit.

Further, in the printing apparatus, there may be employed a configuration in which the enabling circuit is provided with a delay circuit (the delay circuit DC in the above one example) including a first resistor (the first resistor R1 in the above one example) and a capacitor (the second capacitor C2 in the above one example).

Further, in the printing apparatus, there may be employed a configuration in which a second resistor (the second resistor R2 in the above one example) that is coupled to the capacitor while the multi-contact switch is switched to an OFF state is further provided. Further, in the printing apparatus, there may be employed a configuration in which, in the power supply circuit, while the multi-contact switch is switched to the OFF state, the electric charge of the capacitor is discharged through the second resistor, and the supply of the main voltage to the switching circuit is disconnected.

Further, in the printing apparatus, there may be employed a configuration in which the resistance value of the second resistor is smaller than the resistance value of the first resistor.

Further, in the printing apparatus, there may be employed a configuration in which the input voltage control circuit generates a reset signal and a plurality of driving voltages, namely, a first voltage (the driving voltage of 3.3 volts in the above one example) supplied to an input/output handler (one of the logic circuits of the control circuit 20 in the above one example), a second voltage (the driving voltage of 1.1 volts in the above one example) supplied to a controller (the CPU of the control circuit 20 in the above one example), and a third voltage (the driving voltage of 1.5 volts in the above one example) supplied to a storage medium (the RAM of the control circuit 20 in the above one example), and supplies, in order of, the first voltage, the second voltage, the third voltage, and the reset signal to the control circuit.

Further, the input voltage control circuit 31 may be configured such that, a reference voltage is preset, and at the time when the voltage of the enable signal input to the second terminal 31B becomes higher than the reference voltage, the three driving voltages and the reset signal are supplied to the control circuit 20 at predetermined timing. In this case, in the input voltage control circuit 31, the reference voltage can be set to, for example, 12 volts, 5 volts, or the like.

Heretofore, the embodiment of the present disclosure has been described in detail with reference to the drawings, but specific configurations are not limited to the embodiment, and any modification, replacement, deletion, and the like may be applied within the scope not departing from the gist of the present disclosure.

What is claimed is:

1. A printing apparatus comprising:
a printing mechanism that performs printing on a medium;
a control circuit that controls the printing mechanism; and
a power supply circuit,
wherein the power supply circuit includes
a main power supply that supplies a voltage,
an input voltage control circuit that, based on the voltage, generates a plurality of driving voltages for the control circuit and a reset signal for the control circuit,
a switching circuit that supplies the voltage to the input voltage control circuit,
an enabling circuit that, based on the voltage, supplies an enable signal to the input voltage control circuit, and
a multi-contact switch that, when being in an ON state, supplies the voltage to the switching circuit and the enabling circuit, and
wherein the input voltage control circuit is configured to
receive the enable signal from the enabling circuit after elapsing a predetermined period of time from the ON state of the multi-contact switch,
generate, based on the enable signal, the plurality of driving voltages and the reset signal, and
supply the plurality of driving voltages and the reset signal to the control circuit at predetermined timing.

2. The printing apparatus according to claim 1, wherein the enabling circuit includes a delay circuit including a first resistor and a capacitor.

3. The printing apparatus according to claim 2, further comprising a second resistance that, when the multi-contact switch is in an OFF state, is coupled to the capacitor, wherein
when the multi-contact switch is in the OFF state, the power supply circuit discharges electric charge of the capacitor through the second resistor, and disconnects the supply of the voltage to the switching circuit.

4. The printing apparatus according to claim 3, wherein a resistance value of the second resistor is smaller than a resistance value of the first resistor.

5. The printing apparatus according to claim 1, wherein the input voltage control circuit generates a first voltage supplied to an input/output handler, a second voltage supplied to a controller, and a third voltage supplied to a storage medium, as the plurality of driving voltages, as well as the reset signal, and supplies, in order of, the first voltage, the second voltage, the third voltage, and the reset signal to the control circuit.

6. A power supply circuit of a printing apparatus including a printing mechanism, the power supply circuit comprising:
a main power supply that supplies a voltage;
a control circuit that controls the printing mechanism;
an input voltage control circuit that, based on the voltage, generates a plurality of driving voltages for the control circuit and a reset signal for the control circuit;
a switching circuit that supplies the voltage to the input voltage control circuit;
an enabling circuit that, based on the voltage, supplies an enable signal to the input voltage control circuit; and
a multi-contact switch that, when being in an ON state, supplies the voltage to the switching circuit and the enabling circuit,
wherein the input voltage control circuit is configured to
receive the enable signal from the enabling circuit after elapsing a predetermined period of time from the ON state of the multi-contact switch,
generate, based on the enable signal, the plurality of driving voltages and the reset signal, and
supply the plurality of driving voltages and the reset signal to the control circuit at predetermined timing.
